(19) United States
(12) Patent Application Publication
(10) Pub. No.: US 2003/0046355 A1
(43) Pub. Date: Mar. 6, 2003

(54) Method and apparatus for object based information flow management

(75) Inventors: Seth Rosenberg, Broomall, PA (US); Timothy Brennan, Middletown, DE (US)

Correspondence Address: Jules E. Goldberg, Esq., Reed Smith LLP, 599 Lexington Avenue, 29th Floor, New York, NY, 10022, US

(73) Assignee: Evolveworks, Inc.

(21) Appl. No.: 10/230,894

(22) Filed: Aug. 29, 2002

Related U.S. Application Data
(60) Provisional application No. 60/316,331, filed on Aug. 31, 2001.

(51) Int. Cl. G06F 15/16; G06F 9/00; G06F 9/46

(52) U.S. Cl. 709/206; 709/328

(57) ABSTRACT

An application-based communication system, method, and protocol are disclosed. The system includes at least two communicating agents, wherein each of the communicating agents hosts at least a portion of a plurality of information, and wherein the at least a portion of the plurality of information is accessible via an application interface communicatively connected to each of the communicating agents. The protocol includes at least one entity object and at least one association object, wherein each object is pre-registered within the application interface on at least one of the at least two communicating agents. The at least one entity object, and the at least one association object, are accessible by accessing at least one address, and a first of the at least two communicating agents is capable of updating the portion of the plurality of information in at least one second of the at least two communicating agents by exchanging the at least one address. The method includes the steps of transmitting at least one association object from a first to a second of the at least two communicating agents, and transmitting at least two entity objects from the first to the second of the at least two communicating agents.

### CROSS REFERENCE TO RELATED APPLICATIONS

This application claims the right of priority to U.S. Provisional Patent Application Serial No. 60,316,331 filed Aug. 31, 2001.

### STATEMENT REGARDING FEDERALLY SPONSORED RESEARCH OR DEVELOPMENT

Not Applicable.

### BACKGROUND OF THE INVENTION

1. Field of the Invention

The present invention is directed generally to a method and apparatus for managing information and data flow between points and, more particularly, to an apparatus and method for object based information flow management.

2. Description of the Background

Historically, a company or an individual desiring to engage in information management, such as the management of contact lists or calendars, had two options available. The first of these options was the purchase of an expensive on-site site server-based system, and the second was the use of a web-based system.

The first option does not present a central storage area that can be used across multiple organizations, or among multiple individuals not within the same organization. The on-site server system is complex to set up, and must be maintained, administrated, and updated on-site. On-site server applications, in general, are not optimized for communication-over the internet, due to the fact that such systems are not designed for cross-organizational information sharing.

The second option, a web-based system, offers storage at a central site, and eliminates the need, on the part of a company or individual, to purchase and maintain expensive on-site equipment. However, a web-based system offers little flexibility in the manner of accessing the system, as only web-enabled devices can communicate, via web-based methodologies, with the system, and the system is accessible only when a communicative connection is present. Thus, mis-matched protocol devices are not interoperable with web-based systems. Additionally, a web-based device, due, in part, to the nature of an internet connection, is often slow, inefficient, and frustrating to use. Further, a web-based system may be further slowed by the need to access an entire application, and all the functionality offered therefrom, over an internet connection.

Therefore, the need exists for information flow management that may be accessed from any communication device, irrespective of internet interoperability, that does not require expensive on-site equipment, that provides a central access point and data management point, that provides increased access speed, and that improves information flow between all devices, including devices operating on mismatched protocols.

### BRIEF SUMMARY OF THE INVENTION

The present invention is directed, in part, to an application-based communication system and protocol. The system includes at least two communicating agents, wherein each of the communicating agents hosts at least a portion of a plurality of information, and wherein the at least a portion of the plurality of information is accessible via an application interface communicatively connected to each of the communicating agents. The protocol includes at least one entity object and at least one association object. Each object is preferably an independent data item, and each entity object and association object include at least one identifier. Each class identifier is pre-registered within the application interface on at least one of the at least two communicating agents, and each association object links at least two entity objects in accordance with at least one of the pre-registered identifiers. The at least one entity object, and the at least one association object, are accessible by accessing at least one logical address, and a first of the at least two communicating agents is capable of updating the portion of the plurality of information in at least one second of the at least two communicating agents by exchanging the at least one address from the first communicating agent to the at least one second communicating agent. The system may additionally include a communicating host in the form of an entry-way, wherein the entry-way includes the application interface to communicate with the application interface on the second communicating host, such as a central server. The entry-way may then communicate with devices that do not operate using the protocol of the present invention.

Additionally, the present invention is directed, in part, to a method of updating display data, between at least two communicating agents, using an object-oriented application-based communications protocol, wherein each communicating agent hosts at least a portion of a plurality of information, and wherein the at least a portion of the plurality of information is accessible via an application programming interface. The method includes the steps of transmitting at least one association object from a first of the at least two communicating agents to a second of the at least two communicating agents, and transmitting at least two entity objects from the first of the at least two communicating agents to the second of the at least two communicating agents. The at least one association object links the at least two entity objects, and each of the at least one association object and the at least two entity objects includes an identifier. The identifier is pre-registered within the application program interface on each of the at least two communicating agents.

Thus, the present invention provides information flow management that may be accessed from any communication device, irrespective of internet interoperability, that does not require expensive on-site equipment, that provides a central access point and data management point, that provides increased access speed, and that improves information flow between all devices, including devices operating on mis-matched protocols. Those and other advantages and benefits of the present invention will become apparent from the detailed description of the invention hereinbelow.

### BRIEF DESCRIPTION OF THE SEVERAL VIEWS OF THE DRAWING

For the present invention to be clearly understood and readily practiced, the present invention will be described in conjunction with the following figures, wherein like reference numerals designate like elements, and wherein:

FIG. 1 is a block diagram illustrating the communication between a remote unit and a central server;

FIG. 2 is a block diagram illustrating an embodiment of the architecture of the present invention;

FIG. 3 is a block diagram illustrating a connection between at least one remote unit, or at least one entry-way server, and at least one application server; and

FIG. 4 is a relational diagram illustrating the interaction of the four levels of the API employed in FIG. 3.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical information management system and method. Those of ordinary skill in the art will recognize that other elements are desirable and/or required in order to implement the present invention. However, because such elements are well known in the art, and because they do not facilitate a better understanding of the present invention, a discussion of such elements is not provided herein.

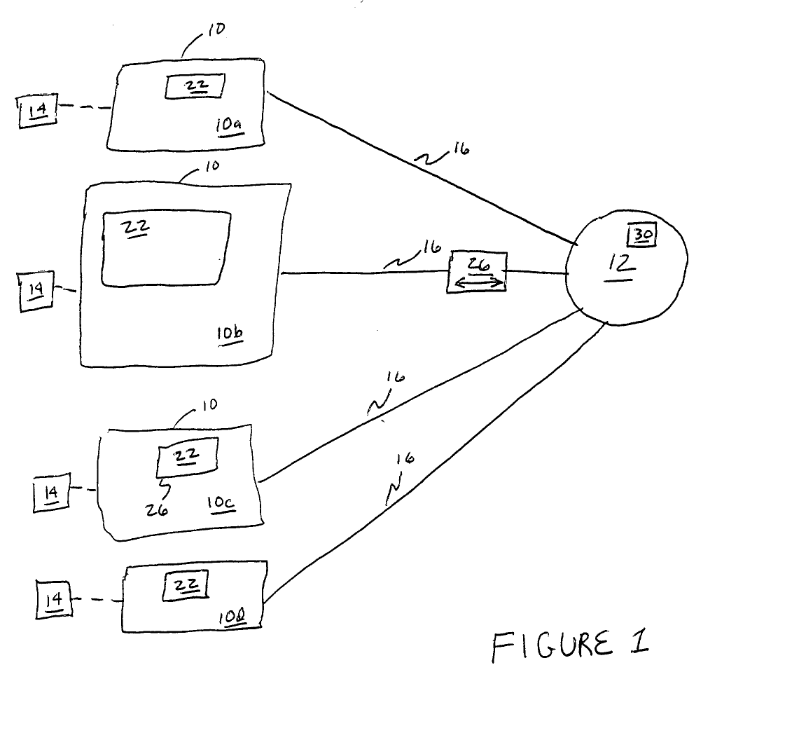

FIG. 1 is a block diagram illustrating the communication between a remote unit 10 and a central server 12. The remote unit 10 is preferably used by a local user 14, such as a user 14 of a personal digital assistant 10a, computer 10b, cellular telephone 10c, or other remote communication device 10d, that is communicatively connected 16 to the central server 12. The central server 12 is a server known in the art, and provides central storage, eliminating the need for an on-site server or back-up at the remote unit 10. The remote unit 10 of the present invention preferably offers immediate response to requests of the local user, which immediate response is preferably enabled by the storage of information responsive to the request 22 at the remote unit 10. This storage 22 may be in a cache at the remote unit 10, and the responsive information for the immediate response is preferably information granted for a previous information request by the local user 14.

In a preferred embodiment, the cached information 22 is immediately displayed on the remote unit 10 to the local user 14 upon a request by the local user 14, irrespective of the existence of a communicative connection 16 to the central server 12. Upon contact with the central server 12, and preferably while the cached information 22 is displayed, the remote unit 10, if authorized to communicate with the central server 12, opens a communicative connection 16 to the central server 12, synchronizes with the central server 12, and downloads any changes necessary to update the information 22 then-currently displayed, and then currently cached, at the remote unit, to updated responsive information 26. The cached information 22 is then preferably updated with the updated responsive information 26 upon receipt at the remote unit 10.

Authorization of the remote unit 10, or of the local user 14, by the central server 12, may be in the form of a user registration, and may include the entry of a plurality of user information 30 unique to that user. Subsequent authorizations to the first authorization may or may not include the entry of, for example, a password and/or login name unique to that local user 14, in order to access the previously entered user information 30. Further, subsequent authorization may include an automated login, as is known to those skilled in the art.

A plurality of responsive information 26 is preferably available via download from the central server 12, and a copy of at least a portion of the plurality of responsive information 22 is preferably cached at the remote unit 10, as discussed hereinabove. For example, information may be available on each user authorized to use the central server 12, such as the contacts and the calendar for each local user 14. In a preferred embodiment, authorized local users 14 of the central server 12 are differentiated from users that are not authorized to use the central server 12, both at the central server 12 and upon display on the remote unit 10. For display at the remote unit 10, this differentiation may be performed, for example, by a color differentiation differentiating authorized users from non-authorized users. For example, in the instance wherein a local user 14 accesses the system and accesses his or her contacts list, other authorized users of the system in the contact list will be highlighted in a particular color different from the non-authorized users.

Each authorized user 14 of the system may uniquely authorize or not authorize particular other authorized users of the central server 12 to access all, or a portion of, his or her information 30 from the central server 12. For example, authorized user A may authorize authorized user B to access the contacts list of authorized local user A. This authorization by one authorized user to allow one or more selected other authorized users to access at least a portion of his or her information is termed “sharing”. In one embodiment of the present invention, in the instance wherein authorized local user A has accessed the contact list of authorized local user B, any secondary authorized users in the contact list of authorized local user B that have authorized user A to access the contacts of that or those secondary authorized user(s) are then accessible by authorized user A, and so on.

The authorized use by other users of all or a portion of the information of each local user information 30 is preferably authorized by a plurality of security settings for each information item of each user. It will be apparent to those skilled in the art that the present invention is operable using prior art methods wherein one security setting is applied to each user profile, rather than individualized security settings for each item of user information 30. In an exemplary embodiment, where security settings allow a plurality of users to share contacts and/or calendars, any first authorized user could, for example, access and overlay the schedules of any number of authorized users authorizing the first authorized user to access the calendars of those authorized users, and the first authorized user could then conveniently generate a meeting time when all other necessary authorized users were available to meet. The first authorized user can then enter a meeting time into the first user's schedule, and, dependent upon the security relation between the first and the other users, the meeting may then automatically be entered into certain of the other authorized user's schedules, and invitations to the meeting may be sent to certain other of the other authorized users, which other authorized users “share” information with the first authorized user.

It will be apparent to those skilled in the art that sharing can occur not only between members of one organization, but among members of numerous organizations, wherein each of the users between the different organizations are authorized users of the central server, and wherein authorized users of each organization authorize users in other organizations to access information. For example, through the use of the present invention, an authorized user in company A is able to generate available meeting times as between companies A, B and C, and between whatever personnel the authorized user desires to set up those meetings, if companies B and C, or authorized users therein, “share” information with company A, or at least one authorized user therein.

The present invention is enabled via the communication between the remote units 10 and the central server 12 that is shared among all authorized users. Each remote unit 10 communicates directly with the central server 12 via the communicative connection 16, but does not necessarily communicate with elements within the central server 12 through a browser, or through a particular assigned communication language. Thus, the present invention is a front-end, application based methodology and apparatus, rather than a web-based apparatus and method, and thereby allows an interaction between remote units 10 employing varied communication methodologies. Nonetheless, the present invention may additionally be employed to communicate over a web-based environment. The direct communication from the remote unit 10 to the central server 12 allows the aforementioned caching to be performed at the remote unit 10, thereby allowing offline updates to the local user information 30, and later synchronization with the central server 12 for downloading of the information 30 to the central server 12 for updating. The present invention is applicable, for example, in the use of contacts, calendars, document management, instant messaging, PDA synchronization, file transfer, reminders, and the like.

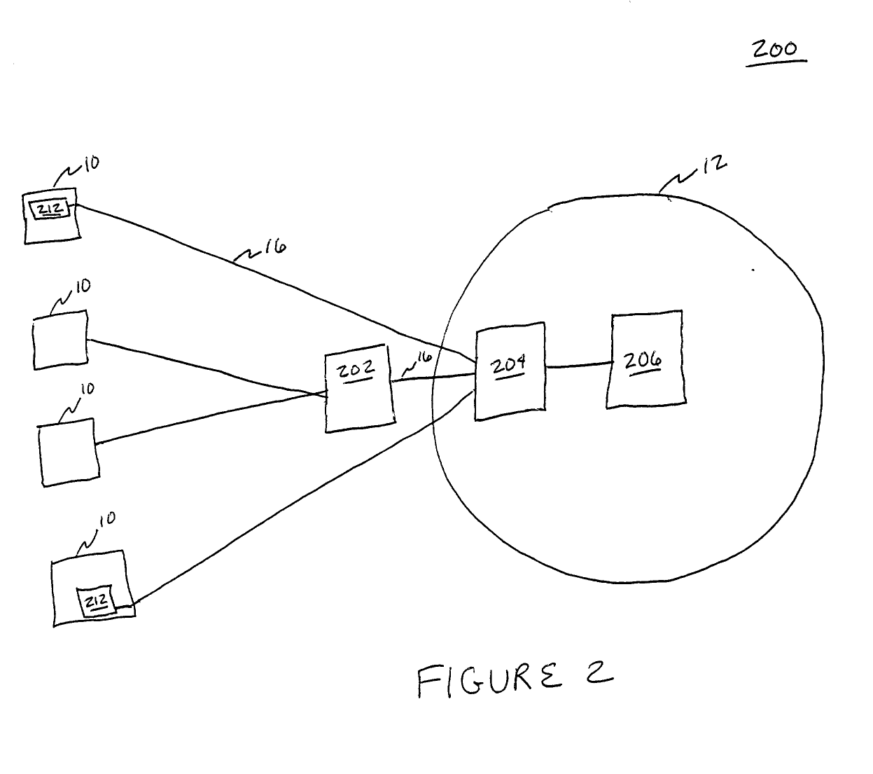

FIG. 2 is a block diagram illustrating an embodiment of the architecture 200 of the present invention. The architecture 200 of the present invention may include, for example, a cellular telephone 10, linked to an entry-way server 202, such as a web server, which web server may include an ASP, Java Service Page, or the like, for example. The entry-way server 202 is communicatively connected to a at least one application server 204 resident on the central server 12. Further, the at least one application server 204 is communicatively connected to a data base 206 at the central server 12. Additionally, a computer 10, such as a lap top or desk top computer, or a personal digital assistant 10, for example, is shown directly communicatively connected to the application server 204 or servers at the central server 12.

In one embodiment of the present invention, only the application server 204 or servers at the central server 12 communicate directly with the data base 206. Thus, it should be noted that the computer and/or the personal digital assistant shown are direct clients of the application server 204, and additionally the web server 202 is a direct client. The cellular telephone, or other remote unit 10, that must dial into the web server 202 is not a direct client of the database 206. Therefore, communications entering the web server 202 are translated by the web server 202 for communication with the application server 204 or servers, and communications from the computer 10 or PDA 10 are translated by application software 212 on the computer or PDA 10 for communication with the application server 204 or servers. Thus, the present invention operates irrespective of the communication protocol of the remote unit 10, as all remote units 10 are either directly in contact with the application server 204, using protocol known to the application server 204, or are translated by, for example, the web server 202, into the protocol of the application server 204.

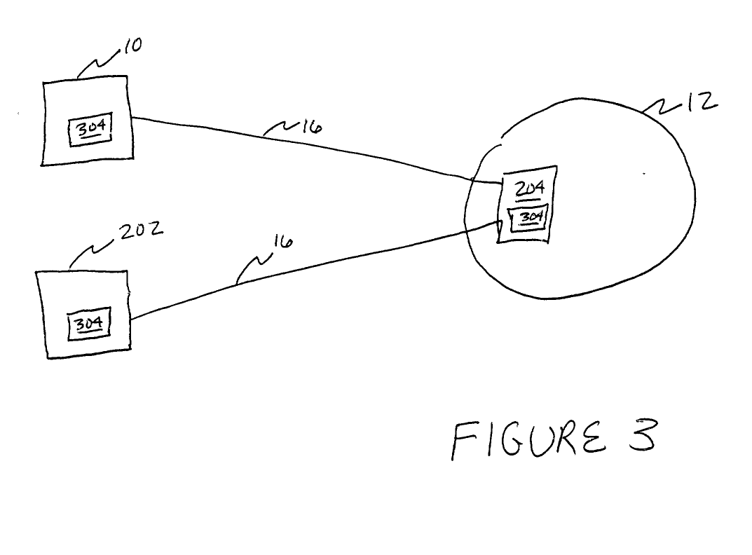

FIG. 3 is a block diagram illustrating a connection 16 between at least one remote unit 10, or at least one entry-way server 202, and at least one application server 204. The communication connection 16 between the remote unit 10, or the entry-way 202, and the application server 204 is a true object based protocol, and thus each of the at least one remote unit 10, or the at least one entry-way 202, and the at least one application server 204 preferably includes an object based SDK thereon, and each SDK includes a common application program interface (“API”) 304. The term “object” is used herein in a generic sense, and need not be C++, xml, or the like, or any particular computer language. The object based communication 16 illustrated in FIG. 3 is an SDK preferably having a four level API 304. Each API level allows for application programming and communication consistent with that level. The first level is the object structure level, the second is the communication level, the third is the security level for each object in the object structure level, and the fourth is the function level.

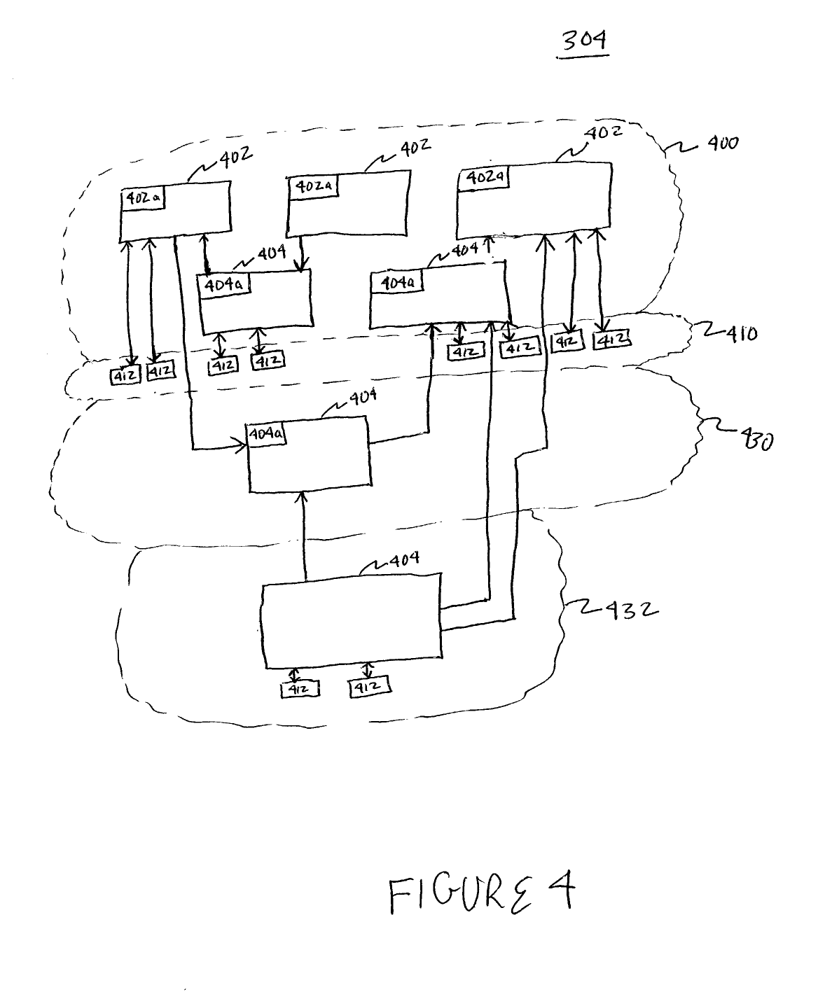

FIG. 4 is a relational block illustrating the interaction of the four levels of the API 304 employed in FIG. 3 hereinabove. The object model structure level 400 is an “entity-association model” (“EAM”). An entity 402 in the EAM is a finite information item, or a finite “object”, such as a name, an address, a time, a location, a telephone number, or a job title, for example. An entity 402 is preferably not a complete employee record, in that an entity 402 may be merely a single field of a complete employee record, such as a telephone number, but implies no relationship between fields, such would be implied in a complete employee record. It will be apparent to those skilled in the art that the present invention is applicable not only to a complete employee record, but also to, for example, a complete meeting schedule, including a time, a location, and an attendee list.

An association 404 describes a relationship between entities 402. For example, entity A may be the name of a person, and entity B may be a telephone number, and an association between the two entities may be that entity B may be the work telephone number for entity A. Each of an entity 402 and an association 404 is, in and of itself, an object. Thus, an association class, such as business telephone number, inherits from, for example, a telephone number, and, similarly, a home telephone number, a fax telephone number, and the name of the person to whom each is associated are interrelated by association objects 404. Thus, the class, or type, of an association must be specified in order to specify an association object 404. Association objects 404 are subject to certain rules, which rules will be apparent to those skilled in the art. For example, a telephone number entity preferably cannot be associated via an association object 404 as the e-mail address entity for a person entity.

Consequently, in operation, no foreign keys are necessary to create new relationships between entities 402 in the present invention. Rather, existing association objects 404 are employed, or new association objects 404 are created, and those association objects 404 operate on already-existent entities 402. Thus, the database 206 of FIG. 2 preferably includes only objects, in the form of entity objects 402 and association objects 404, addressed in the database 206 by memory addresses, and the API 304 of the present invention pieces the objects together from the data base 206 in order to create communication between the central server 12 and the remote unit 10.

Each entity 402 preferably has a class identifier and a unique logical instance identifier 402a, and each association 404 similarly has a class identifier and a unique logical identifier 404a. Associations may include, for example, a first column of the association class I.D., a second column of the association unique I.D., a third column of entity one I.D., and a fourth column of associated entity to I.D, wherein each entity includes an identifier that assures that columns three and four can be properly associated in light of the rules discussed hereinabove. It should be noted that, in general, association objects 404 operate on entity objects 402 in a one way fashion. In other words, if person A is a contact of person B, person B may be, but is not necessarily, a contact of person A. This true object oriented methodology of communication between the remote unit 10 and the central server 12 in the present invention allows for a substantially higher data update rate, thereby increasing refresh rates, than a typical communication protocol, as discussed hereinbelow. Further, the caching of information from a previous use, as discussed hereinabove, allows for the display of information to a local user 14 desiring to see information without a wait period, and the removal of the wait period in the prior art, in conjunction with the improved data update rate of the present invention, allows for an increased speed of use of the present invention.

The second level 410 of the communication methodology is the communication within and between the APIs 304. The pieces of an entity object 402, or an association object 404, are objects in and of themselves. For example, the first name in a name field entity is an object. “Atoms” 412 inherit from objects, and, consequently, an atom is an integer, for example, in a date/time, or a portion of a logical address pointer, and is thus a minimum sized information item. Each atom preferably possesses knowledge of the manner in which that atom reads itself to, and writes itself from, the stream discussed hereinbelow.

In the present invention, each object 402, 404 has the capability to read and write atoms 412. For example, a series of atoms 412 is preferably saved, such as into the central database 206, or into the cache 22 of the remote unit 10, as a block of bits, also called a stream. In order to perform communication between the remote unit 10 and the central server 12, each of the remote unit 10 and the central server 12 must include a capability to write to the stream, and to read from the stream. The read and write capability is defined for each atom 412 of the stream, as discussed further hereinbelow.

The stream may or may not include information on the information items, or the order of the information items, included in the stream. For example, the class I.D. of an object 402a, 404a may be read from the stream, or a class I.D. may be written to the stream, or no class may be included in the stream. When the class I.D. is included in the stream, the receiver of the communication can construct the objects sent based upon the streamed bits received, in accordance with the class I.D. instruction. For example, wherein the class I.D. is written to the stream, followed by the data bits written to the stream, the receiver can, upon receipt, first read the class I.D., and then read the stream in accordance with the class I.D. received.

As discussed hereinabove, the class I.D.s 402a, 404a are preferably pre-registered at each end of the communication stream, i.e. at the remote unit 10 and at the central server 12. Therefore, upon receipt of, or upon writing of, information, the information read or written is classified according to the already pre-registered class. For example, a class I.D. 402a may be written to the stream having entity class “person name”. The data streamed may then include atoms 412 that form the last name first, followed by the first name, followed by the middle initial. Upon receipt at the receiving end of the stream, the receipt of the pre-registered class I.D. “person name” instructs the receiver 10, 12 that the data structure that follows is known, and the bits will be streamed in a particular order for reconstruction. Alternatively, only logical addresses of the unique identifier may be streamed, which logical addresses of the unique identifier may point to the atom information desired, which atom information has been pre-registered at both the sender and receiver, and, as such, may be referred to solely by the commonly-known logical address of the unique identifier.

Similarly, each association has a pre-registered I.D 404a. This association I.D. 404a is preferably streamed to evidence a particular association object between entity objects that follow, such as the association that the telephone number entity object (or logical address of the telephone number entity object) that immediately follows the association object (or logical address of the unique identifier of the association object) in the stream is the number of the person entity object (or logical address of the unique identifier of the person entity object) that follows after the telephone number object. The bit stream in this example might continuously include the atoms that form the association, the atoms the form the telephone number, followed by the atoms that form the name of the person to whom the telephone number belongs. Alternatively, rather than receiving the atoms of the association, the actual telephone number, or the actual atoms of the name, for example, a pointer is instead received, wherein the pointer is the pointer discussed hereinabove, and wherein the pointer points to a logical address of the unique identifier in the database 206, or in the remote unit 10, that includes the necessary data. Thus, the pointer to a logical addresses of the unique identifier is received, and the necessary data is accessed from that logical address in, for example, the central database 206, and an association may then be created between the data in the addresses pointed to, in accordance with the I.D., i.e. the type, of the association object received.

Through the use of the present invention, associations, and the entities associated thereby, are streamed with a minimal amount of data flow. As set forth hereinabove, through the receipt of an association class I.D. and/or pointer, the receiver may be informed that the association is a link between two entity objects to be received in the data stream via a receipt of pointers to the objects. Thus, the only information that must be transmitted is an I.D. or pointer to an association, followed by pointers to be associated by the association I.D. Consequently, in order to create new tasks, such as new commands, or new associations, with the API 304, only pre-registration with the API 304 of the new task, command, or association I.D., or the memory address thereof, must be performed, and no manipulation of the entity data, or then-current association data, in the database 206 need be performed. Further, in order to enter new data information, all that need be streamed is a command to create new data information, preferably in the form of an object, such as a pointer, and/or an association object between the new data information to be streamed thereafter, such as in the form of a pointer, and the atoms that make up the new data information. Thus, the convenience of data base 206 upkeep and updating is substantially improved through the use of the present invention, and the speed of entry for new data, associations, or commands, is substantially increased.

The third level of the API 304 is the security level 430 for each data item. Security is preferably merely an association object 404 in the present invention, wherein the association associates a particular security association object A for an entity object B as to entity association object C, wherein entity object B is otherwise associated with entity object D, such as entity object B being the telephone number for a person entity D. For example, each entity object 402 may have a security profile associated with it by an association object 404, and that security profile is itself an object. The use of entity objects 402 and association objects 404 eliminates many of the security tasks necessary in the prior art. For example, a home profile and a work profile may each be association objects that associate particular entity objects for a particular individual in the present invention, and each such profile may each have different security levels associated therewith for the entity objects associated therewith. Additionally, different associations may be available for each entity object. For example, wherein entity A allows entity B, via a security profile object, to view the contacts of entity A, entity A may still not allow entity B to see that the contacts are associated with entity A. In this manner, security may be employed in a plurality of ways. For example, rather than assigning all available and desired parties into a meeting on the shared schedule, the security level for a particular entity, such as a staff member of a company, may only allow that entity to send out invitations to a meeting at a given time or any given place, rather than assignments, which may only be sent by a party having managerial security. Thereby, security levels may be varied by entity, such that entity B may only view the name and business telephone number, but not the home telephone number, of entity A, or such that the head of a department has the ability to assign personnel to a meeting, while a member of the staff of the department head may only invite personnel to a meeting.

The fourth level is the function level 432. The command set of the present invention is also series of objects, which objects are streamable, and may be streamed in an assigned order, such as first streaming a stream identification, then streaming at least one object, then streaming operation commands, and then streaming command parameters. Thus, new functional commands may be added in the present invention by creating the new commands as new objects, and pre-registering that new command object into the API, as discussed hereinabove. The present invention may thus be functional in any programming language, and programming languages at points between the remote unit and the application server, such as at the entry-way, may be mixed and matched. The present invention is dependant only upon streaming and pre-registration, and is dependent only upon communication between the APIs 304.

Those of ordinary skill in the art will recognize that many modifications and variations of the present invention may be implemented. The foregoing description and the following claims are intended to cover all such modifications and variations.

What is claimed is:

1. An application-based communication protocol, between at least two communicating agents, wherein each of the communicating agents hosts at least a portion of a plurality of information, wherein the at least a portion of the plurality of information is accessible via an application interface communicatively connected to each of the communicating agents, comprising:
at least one entity object; and
at least one association object;
wherein each object is an independent data item, and wherein each of said at least one entity object and said at least one association object include at least one identifier, and wherein each identifier is pre-registered within the application interface on at least one of the at least two communicating agents, and wherein each association object links at least two of said at least one entity objects in accordance with at least one of the pre-registered identifiers;
wherein said at least one entity object, and said at least one association object, is accessible by accessing at least one address, and wherein a first of the at least two communicating agents is capable of updating the portion of the plurality of information in at least one second of the at least two communicating agents by exchanging the at least one address from the first communicating agent to the at least one second communicating agent.

2. The protocol of claim 1, further comprising at least one functional command object, wherein said at least one functional command object includes at least one command object identifier, and wherein each command object identifier is pre-registered within the application interface on at least one of the at least two communicating agents;
wherein said at least one functional command object is accessible by accessing at least one command object address, and wherein a first of the at least two communicating agents is capable of updating the portion of the plurality of information including said at least one functional command object in at least one second of the at least two communicating agents by exchanging the at least one command object address from the first communicating agent to the at least one second communicating agent.

3. The protocol according to claim 1, wherein said at least one association object comprises a security for at least one of said at least one entity objects, wherein said security permits access restriction for said at least one of said at least one entity objects.

4. The protocol according to claim 1, further comprising a first host, wherein said first host includes an application interface adapted to communicate with an application interface.

5. The protocol according to claim 4, wherein said first host is adapted to communicate with devices not utilizing the protocol.

6. The protocol according to claim 1, wherein at least one of said at least two communicating agents is adapted for use by a user.

7. The protocol of claim 6, wherein said at least one of said at least two communicating agents includes at least one of a personal digital assistant, a computer, a cellular telephone, and a remote communication device.

8. The protocol of claim 1, further comprising a central server adapted to provide central storage.

9. The protocol of claim 1, wherein said protocol is adapted for immediate response to requests of a user, wherein said immediate response is enabled by storage of information responsive to the requests at the remote unit.

10. The protocol of claim 9, wherein the storage of information occurs in a cache.

11. The protocol of claim 10, wherein the information stored in said cache is displayed on at least one of the at least two communicating agents in response to the request.

12. The protocol of claim 11, wherein said at least one of the at least two communicating agents displaying the information stored in said cache opens a synchronized communicative connection with said central server, and downloads changes to the information stored in said cache and said display.

13. The protocol of claim 1, wherein authorization of said at least one of the at least two communicating agents is a user registration.

14. The protocol of claim 13, wherein said authorization includes the entry of a plurality of user information.

15. The protocol of claim 14, wherein said plurality of user information is unique to a user.

16. The protocol of claim 15, wherein said plurality of user information includes at least one of a password and login name.

17. The protocol of claim 14, wherein said authorization includes an automated login.

18. The protocol of claim 14, wherein said authorization further comprises a share of information wherein said share includes authorizing user access to said information.

19. The protocol of claim 18, wherein said share is authorized by a plurality of security settings.

20. A method of updating display data, between at least two communicating agents, using an object-oriented application-based communications protocol, wherein each communicating agent hosts at least a portion of a plurality of information, and wherein the at least a portion of the plurality of information is accessible via an application programming interface, said method comprising:
transmitting at least one association object from a first of the at least two communicating agents to a second of the at least two communicating agents; and
transmitting at least two entity objects from the first of the at least two communicating agents to the second, of the at least two communicating agents;
wherein said at least one association object links said at least two entity objects, and wherein each of said at least one association object and said at least two entity objects includes an identifier, and wherein the identifier is pre-registered within the application program interface on each of the at least two communicating agents.

21. The method of claim 20, wherein each transmitted entity object is an address of entity data.

22. The method of claim 20, wherein each transmitted association object is an address of association data.

23. The method of claim 21, wherein the entity data, displayed on the first communicating agent, is updated by the second communicating agent to a second entity data, as the entity data is being displayed on the first communicating agent.

24. The method of claim 23, wherein the first communicating agent is a remote terminal and the second communicating agent is a central server.

25. A method of updating display information, between two or more communicating agents, using an object-oriented application-based communications protocol, wherein each communicating agent hosts at least a portion of a plurality of information via an application programming interface, said method comprising:
accessing primary information for display on the first communicating agent, wherein the primary information is displayed from a cache within the first communicating agent;
establishing a communicative connection from the first communicating agent to the second communications agent;
synchronizing the first communications agent with the second communications agent;
transmitting secondary information from the second communications agent to the first communications agent, wherein the secondary information is an update of the primary information; and
updating the displayed primary information on the first communicating agent to the secondary information;
wherein said transmitting of secondary information comprises transmitting addresses for at least one identified association objects that associates at least two identified entity objects.

26. The method of claim 25, wherein the first communicating agent is a remote terminal and the second communicating agent is a central server including a database.

27. The method of claim 26, wherein the remote terminal is one or more selected from the group consisting of a personal digital device, a mobile phone with a display, a desktop computer, and a laptop computer.

28. The method of claim 26, wherein the communicative connection is one or more selected from the group consisting of a hardline, a point to point interface, a hardline network interface, a wireless point to point interface, and a wireless network interface.

29. The method of claim 25, wherein the application program interface on the first communicating device is at least one selected from the group consisting of an e-mail program, an electronic address book, an electronic scheduler, and an electronic telephone book.

30. An object model structure comprising:
a first entity; and,
a second entity, wherein said second entity is related to said first entity by an association;
wherein said first and said second entities each have a class identifier and a unique logical identifier.

31. The object model structure of claim 30, wherein said first entity includes at least one of a name, an address, a time, a location, a telephone number, a job title, a complete meeting schedule, and an attendee list.

32. The object model structure of claim 31, wherein said second entity includes at least one of a name, an address, a time, a location, a telephone number, a job title, a complete meeting schedule, and an attendee list.

33. The object model structure of claim 31, wherein said association has a class identifier and a unique logical identifier.

34. The object model structure of claim 33, wherein said association includes at least one of a first column of the association class I.D., a second column of the association unique I.D., a third column of entity one I.D., and a fourth column of associated entity to I.D.

35. The object model structure of claim 30, further comprising a level of communication within and between the application program interfaces.

36. The object model structure of claim 35, further comprising a security level for each data item.

37. The object model structure of claim 36, wherein said security level associates a particular security association for an entity.

38. The object model structure of claim 36, further comprising a function level.
